(19) United States
(12) Patent Application Publication
(10) Pub. No.: US 2012/0153107 A1
(43) Pub. Date: Jun. 21, 2012

(54) TELESCOPING HANGER

(76) Inventor: Neil Edwards, Kernersville, NC (US)

(21) Appl. No.: 12/973,401

(22) Filed: Dec. 20, 2010

(51) Int. Cl. F16M 13/02; F16M 13/00

(52) U.S. Cl. 248/223.41; 248/298.1

(57) ABSTRACT

A hanger assembly has a first hollow tube for disposition behind a barrier and a second hollow tube mounted for telescoping motion within the first tube. The second tube has an indentation in its shaped outer surface. A body is rotatably mounted within the indentation and has a hanger mounted thereto. The body and the hanger are disposed in the indentation and conform to the first shaped outer surface of second tube if the second tube is disposed in the first tube and the body rotates away from the indentation if the second tube is not disposed in the first tube.

### BACKGROUND

In many residences, space for storing clothing or other things that need to be hung is at a premium.

### SUMMARY

According to an embodiment shown herein, a hanger assembly has a first hollow tube for disposition behind a barrier and a second hollow tube mounted for telescoping motion within the first tube. The second tube has an indentation in its shaped outer surface. A body is rotatably mounted within the indentation and has a hanger mounted thereto. The body and the hanger are disposed in the indentation and conform to the first shaped outer surface of second tube if the second tube is disposed in the first tube and the body rotates away from the indentation if the second tube is not disposed in the first tube.

These and other features of the multiple embodiments described herein can be best understood from the following specification and drawings, the following of which is a brief description.

### BRIEF DESCRIPTION OF THE DRAWINGS

FIG. 1 is a schematic view of a telescoping hanger assembly.

FIG. 1A is a perspective view of the hanger assembly of FIG. 1.

FIG. 2 is a side, partially cut away view of the hanger assembly of FIG. 1 in a second position.

FIG. 2A is a perspective view of the hanger assembly of FIG. 2.

### DETAILED DESCRIPTION

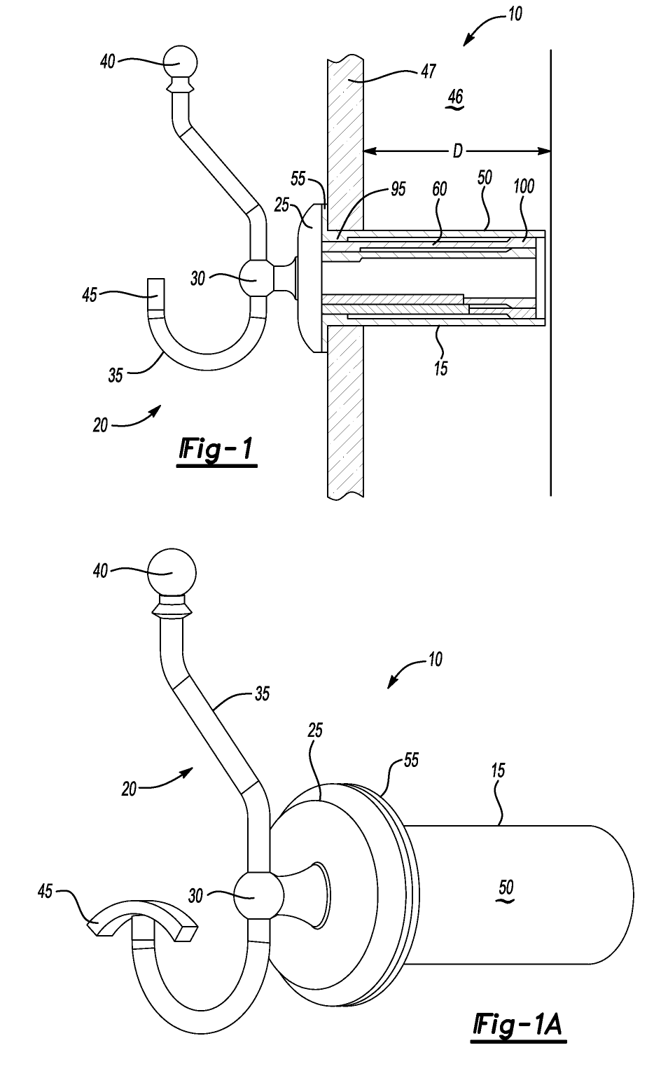

Referring now to FIGS. 1 and 1A an embodiment of a hanger assembly 10 is shown. The hanger assembly 10 includes a telescoping portion 15 and an outer hook 20. The outer hook 20 includes a decorative cover 25, a ball 30 conventionally attached to the cover 25 which supports, via a tortuous-shaped rod 35, an upper hook 40 and a lower hook 45. The exemplary hanger assembly 10 is designed to fit into the space 46 hidden behind the drywall 47, or other barrier, to take advantage of that unused space. The hook 20 may support other shaped hooks and such other shapes are contemplated herein.

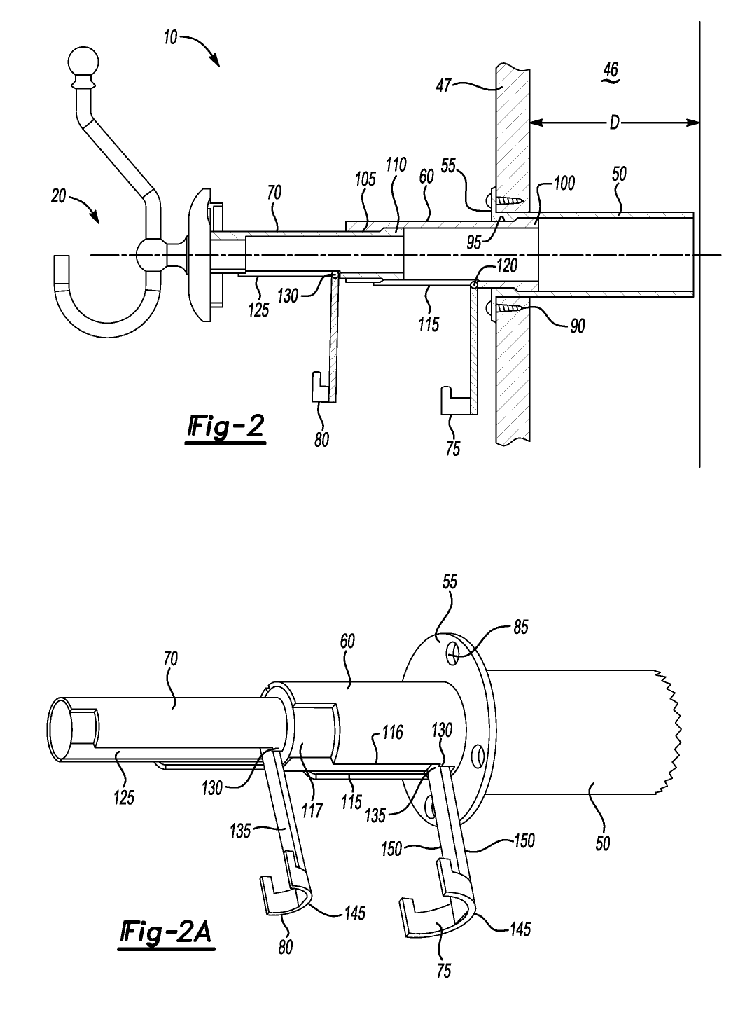

Referring now to FIGS. 1, 2, and 2A, the telescoping portion 15 includes a first hollow tube 50 attached to a flange 55 extending radially outwardly from the first tube 50, a second tube 60 disposed within the first tube 50, and a third tube 70 disposed within the second tube 60. The second tube 60 and the third tube 70 each house a descendible horse-shoe shaped hook 75, 80 respectively as will be discussed herein. The telescoping portion 15 extends longitudinally along axis 87.

Referring now to FIGS. 2 and 2A, the flange 55 has a number of openings 85 through which screws 90 or the like may be inserted to attach the flange 55 and the telescoping portion 15 thereby into the drywall 47.

Referring now to FIGS. 1 and 2, the first tube 50 has an internal area 95 of diminished diameter relative to the diameter of the first tube 50 for stopping an outer area of increased diameter 100 of the second tube 60 relative to the diameter of the second tube 60, to keep the second tube 60 from escaping from the first tube 50. Similarly, the second tube 60 has an internal area 105 of diminished diameter relative to the diameter of the second tube 60 for stopping an outer area of increased diameter 105 of the third tube 70 relative to the diameter of the third tube 70, to keep the third tube 70 from escaping from the second tube 60. If the hook 20 is pulled outwardly from the position shown in FIGS. 1 and 1A, the increased diameter areas 100, 110, cooperate with the decreased diameter areas 95, 105 respectively to prevent the second and third tubes from being separated from the first tube 50 and from each other.

The second tube 60 has a shaped indentation 115 extending partially along a length thereof in which a horse-shoe shaped hook 75 is disposed. The horse-shoe shaped hook 75 is attached within the shaped indentation 115 by means of a pin 120 that allows the horse-shoe shaped hook 75, 80 to rotate thereabout. Similarly, the third tube 70 has a shaped indentation 125 along extending longitudinally therein in which the second horse-shoe shaped hook 80 is attached for rotation about pin 130.

Each horse-shoe shaped hook 75, 80 has a roughly rectangular body 135 having an opening near its top for receiving a pin 120 or 130, a shaped curve back 145, or other shape, to mate with the shape of the tubes 60 and 70 and their respective shaped indentation 115, 125, and rectangular sides 150. At or near a bottom 155 of the body 135, a horse-shoe hanger 160 is joined transversely to the body 135 and to the axis 87 by conventional means. The horse-shoe shaped hooks 78, 80 mate with the shaped indentations 115, 125 so that the second tube 60 may slide into and out of the first tube 50 and the third tube 70 may slide into and out of second tube 60. The shaped indentations 115, 125 each have an elongated portion 116 to mate with the body 135 and a curved portion 117 to mate with a curved shape of the horse-shoe hanger 160. Though a horse-shoe shaped hook is shown herein, other shaped hooks that mate with indentations in tubes so that the tubes may telescope without obstruction are contemplated herein.

During operation, a user may grasp the hook 20 and pull the third tube 70 from the second tube 60 and the second tube 60 from the first tube 50 as gravity causes the horse-shoe shaped hook 75 in the second tube to pivot downwardly from the shaped indentation 115 and gravity causes the horse-shoe shaped hook 80 in the third tube 70 to pivot downwardly from the shaped indentation 125. As shown in FIGS. 2 and 2A a user will have two more hooks from which clothing may be disposed. Conversely, to stow the hanger assembly 10, the hook 20 is pushed and the third tube 70 enters the second tube 60 and the second tube 60 enters the first tube 50. As tubes 60, 70 move axially, the horse-shoe shaped hook 75 in the second tube strikes the flange and pivots upwardly into the shaped indentation 115 and the horse-shoe shaped hook 80 strikes second tube 60 and pivots upwardly into the shaped indentation 125. Because the horse-shoe shaped hook 75 and the horse-shoe shaped hook 80 are flush with the second and third tubes 60, 70 respectively, the third tube 70 smoothly enters the second tube 60 and the second tube 60 smoothly enters the first tube 50.

The area 46 between the behind the drywall is usually 3-½″ (i.e., D) and therefore the first or second or third tubes may not extend longer than 3-½″ plus the width of the drywall 47 which is usually ⅜″. A width of 3 ¼″ may be used to account for wall variations.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

1. A hanger assembly comprising:
a first hollow tube for disposition behind a barrier,
a second hollow tube mounted for telescoping motion to a front of said barrier and within said first tube and wherein said second tube has a first indentation in a first shaped outer surface thereof, and
a first body rotatably mounted within said first indentation, said first body having a first hanger mounted thereto and wherein said first body and said first hanger are disposed in said indentation and conform to said first shaped outer surface of second tube if the second tube is disposed in the first tube and said first body rotates away from said first indentation if said second tube is not disposed in said first tube.

2. The hanger assembly of claim 1 wherein said first hanger is horse-shoe shaped.

3. The hanger assembly of claim 1 wherein said first tube and said second tube have a cylindrical shape.

4. The hanger assembly of claim 3 wherein said first hanger has a curved shape to conform with a cylindrical shape of said second tube.

5. The hanger assembly of claim 1 wherein said first hanger is mounted transversely to said first body.

6. The hanger assembly of claim 1 wherein said barrier is a wall.

7. The hanger assembly of claim 1 further comprising;
a third tube mounted for telescoping motion within said second tube and said first tube, and wherein said third tube has a second indentation in a second shaped outer surface thereof, and
a second body rotatably mounted within said second indentation, said second body having a second hanger mounted thereto and wherein said second body and said second hanger are disposed in said second indentation and conform to said second shaped outer surface of said third tube.

8. The hanger assembly of claim 7 wherein said second hanger is horse-shoe shaped.

9. The hanger assembly of claim 7 wherein said first tube, said second tube, and said third tube have a cylindrical shape.

10. The hanger assembly of claim 9 wherein said second hanger has a curved shape to conform with a cylindrical shape of said second tube.

11. The hanger assembly of claim 7 wherein said second hanger is mounted transversely to said second body.
